(19) United States
(12) Patent Application Publication
(10) Pub. No.: US 2015/0363354 A1
(43) Pub. Date: Dec. 17, 2015

(54) Calculator

(71) Applicant: Wen-Fu Chang, Hsinchu City (TW)

(72) Inventor: Wen-Fu Chang, Hsinchu City (TW)

(21) Appl. No.: 14/446,616

(22) Filed: Jul. 30, 2014

(30) Foreign Application Priority Data
Jun. 16, 2014 (TW) 103210582

(51) Int. Cl. G06F 15/02

(52) U.S. Cl. CPC G06F 15/0225

(57) ABSTRACT

A calculator that comprises an inputting member, a calculating member and a displaying member, wherein the calculating member is provided for calculating the value of the expression by means of a processing unit and generating a calculated result, and the displaying member has a displaying area, in which the displaying member displays the expression and the corresponding calculated result by the processing unit, so as to provide convenience for the users.

### FIELD OF THE INVENTION

The present invention is related to a calculator, and more particularly, to a calculator that displays an expression and the calculated result of the expression at the same time.

### BACKGROUND OF THE INVENTION

A calculator now is designed as a small handset device or a desktop device for executing mathematical calculations. A mathematical calculator not only provides simple calculation of basic arithmetic such as elementary arithmetic and multiplicative inverse, but also provides function complex arithmetic such as tangent, cotangent and arctangent, logarithm arithmetic, factorial arithmetic and exponential arithmetic and so on. A calculator is usually more portable than a computer and different in terms of functionalities where a mathematical calculator is only able to perform arithmetic calculations with limited logical operations by displaying the calculated results. The conventional calculator is normally not allowed to execute a modification of the expressions. When a conventional calculator handles a massive calculation, it only displays the calculated result, so it is inconvenient for the user to verify whether the calculation is correct or not. The verification of the conventional calculator can only be done doing the calculation again.

### SUMMARY OF THE INVENTION

According to the above, an objective of the present invention is to provide a calculator to solve the technical issue in the prior art.

The present invention comprises an inputting member, a calculating member and a displaying member. The inputing member is provided for a user to input an expression. The calculating member is provided for calculating the value of the expression by means of a processing unit and generating a calculated result. The displaying member has a displaying area, in which the displaying member displays the expression and the corresponding calculated result of the expression calculated by the processing unit.

According to an embodiment of the present invention, the expression and the calculated result of the expression are correspondingly stored in a memory.

According to an embodiment of the present invention, the displaying member receives a displaying signal of the expression via the processing unit so as to display the expression and the corresponding calculated result of the expression in the displaying area.

According to an embodiment of the present invention, the displaying signal of the expression is generated after a user taps an expression displaying button of the inputting member.

According to an embodiment of the present invention, the displaying area is able to display plural pairs of expression and the corresponding calculated result of the expression.

According to an embodiment of the present invention, the calculator further comprises an expression modifying member which uses the processing unit to modify the expression displayed in the displaying area on which the expression and the calculated result of the expression is displayed, wherein the modified expression is re-calculated by the calculating member via the processing unit to obtain the calculated result of the modified expression.

According to an embodiment of the present invention, the inputting member has a recalculating button, and the modified expression and the corresponding calculation result of the modified expression are displayed in the displaying area after a user taps the recalculating button.

According to an embodiment of the present invention, the inputting member has an initial-screen returning button, by which an initial-screen is displayed in the displaying area after a user taps the initial-screen returning button.

By means of technical means of the present invention, it is able to fulfill the demand of the user by displaying the expression and the corresponding calculated result of the expression in the displaying area, and the operation with simplicity of the present invention also provides the user a convenience in use.

The structure and the technical means adopted by the present invention to achieve the above and other objects can be best understood by referring to the following detailed description of the preferred embodiments and the accompanying drawings.

### BRIEF DESCRIPTION OF THE DRAWINGS

FIG. 1 illustrates a block diagram of the calculator according to an embodiment of the present invention.

FIG. 2 illustrates the first schematic drawing of a screen of the calculator according to an embodiment of the present invention.

FIG. 3 illustrates the second schematic drawing of a screen of the calculator according to an embodiment of the present invention.

FIG. 4 illustrates the third schematic drawing of a screen of the calculator according to an embodiment of the present invention.

FIG. 5 illustrates the fourth schematic drawing of a screen of the calculator according to an embodiment of the present invention.

FIG. 6 illustrates the fifth schematic drawing of a screen of the calculator according to an embodiment of the present invention.

FIG. 7 illustrates the sixth schematic drawing of a screen of the calculator according to an embodiment of the present invention.

FIG. 8 illustrates the seventh schematic drawing of a screen of the calculator according to an embodiment of the present invention.

FIG. 9 illustrates the eighth schematic drawing of a screen of the calculator according to an embodiment of the present invention.

### DETAILED DESCRIPTION OF THE PREFERRED EMBODIMENTS

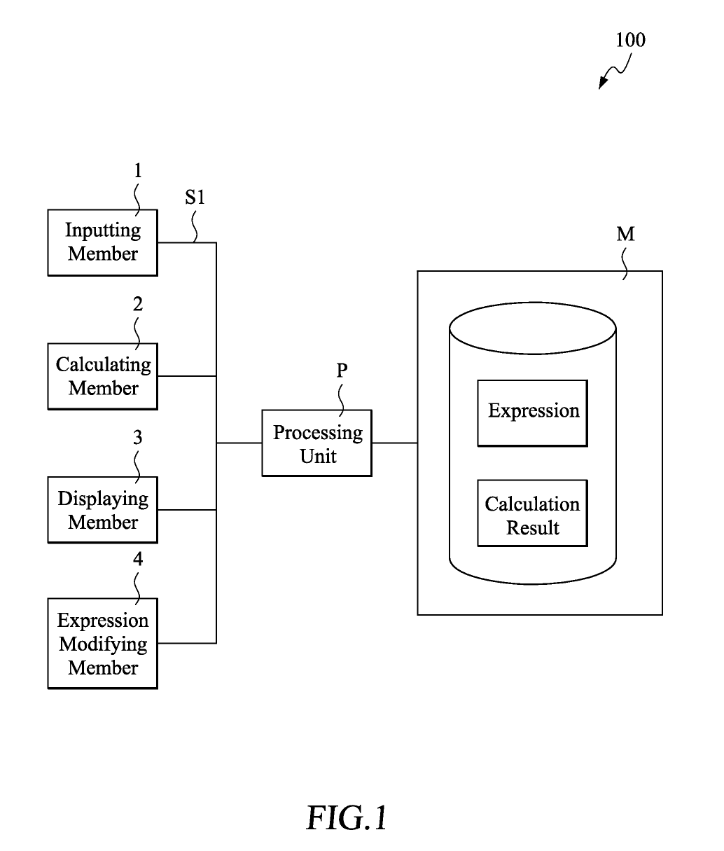

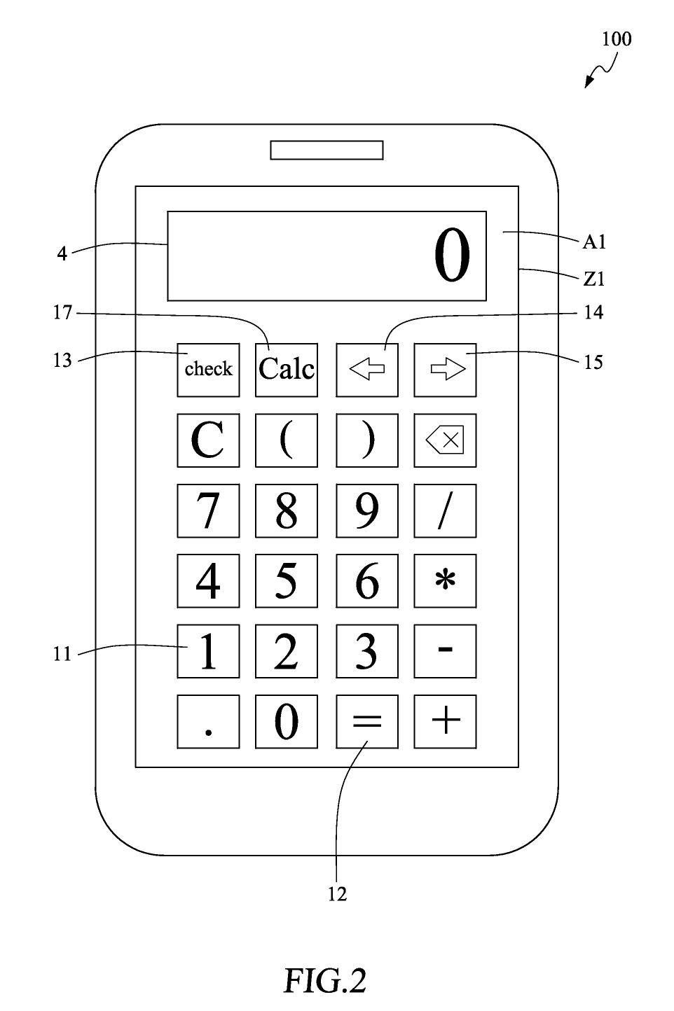

Embodiments are described in detail below with reference to the FIG. 1 and FIG. 2. According to an embodiment of the present invention, a calculator 100 comprises an inputting member 1, a calculating member 2 and a displaying member 3.

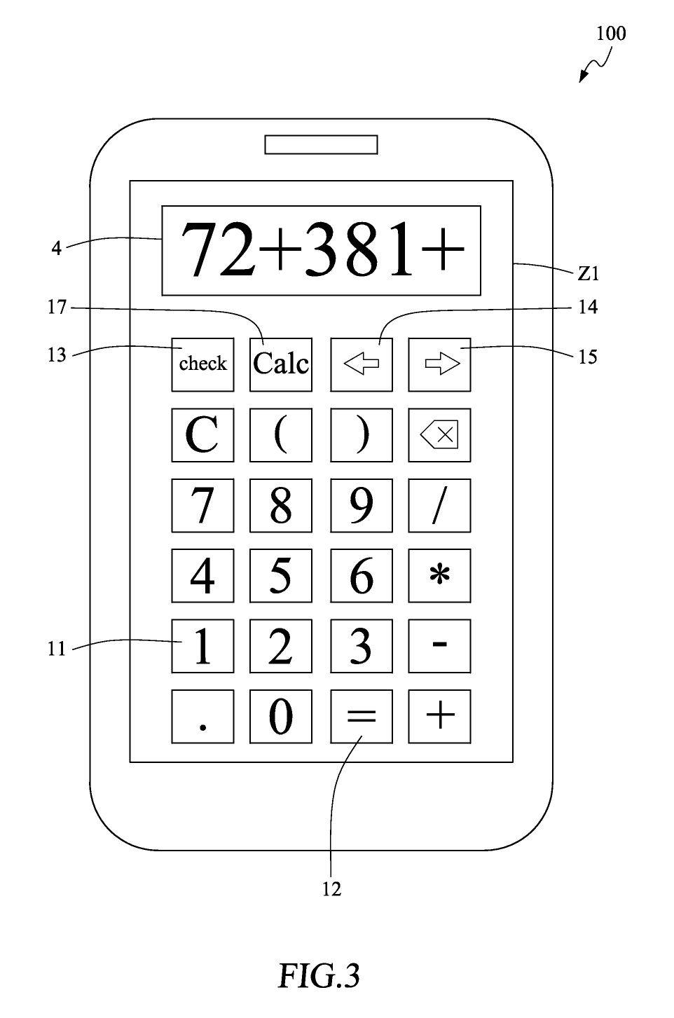

The inputting member 1 is provided for a user to input an expression. An initial screen A1 of the calculator 100 is as shown in FIG. 2. The displaying member 3 has a displaying area Z1, in which a displaying frame 4 and a plurality of inputting buttons 11 of the inputting member are displayed. Each of the inputting buttons 11 represents a digit or arithmetic symbol respectively. A user can input an expression by tapping a plurality of the inputting buttons 11 or other methods, and then the input expression will be displayed in the displaying frame 4, as shown in FIG. 3.

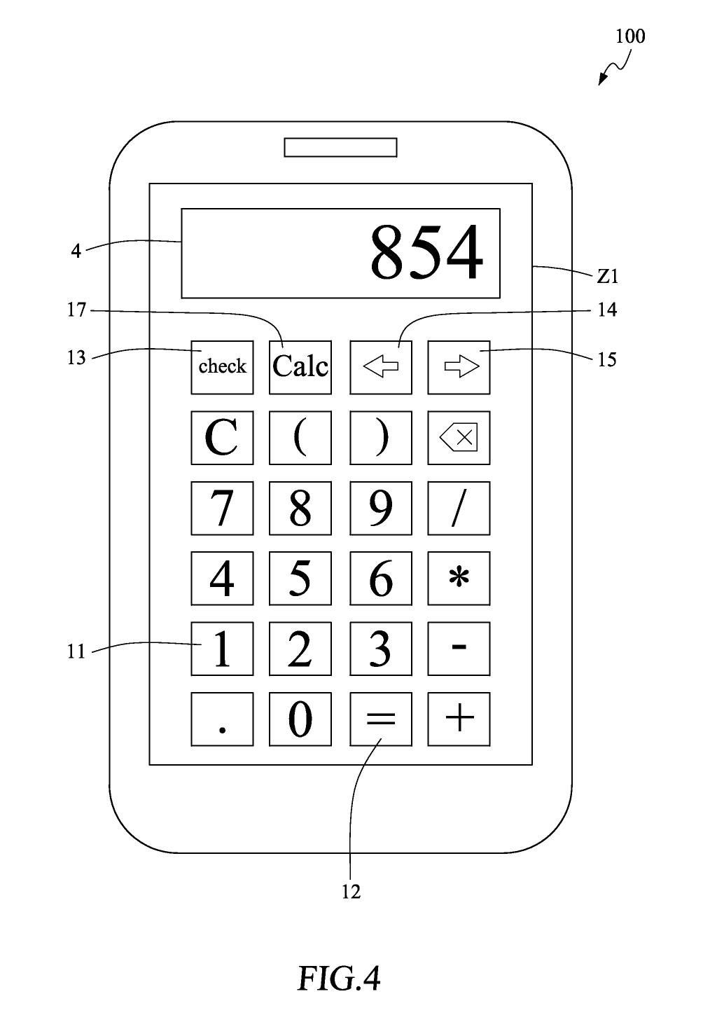

The calculating member 2 is provided for calculating the result value of the expression by means of a processing unit P and for generating a calculated result. Specifically, after the user taps an equal button 12, the calculating member 2 calculates the expression and generates a calculated result to display in the displaying frame 4 as shown in FIG. 4.

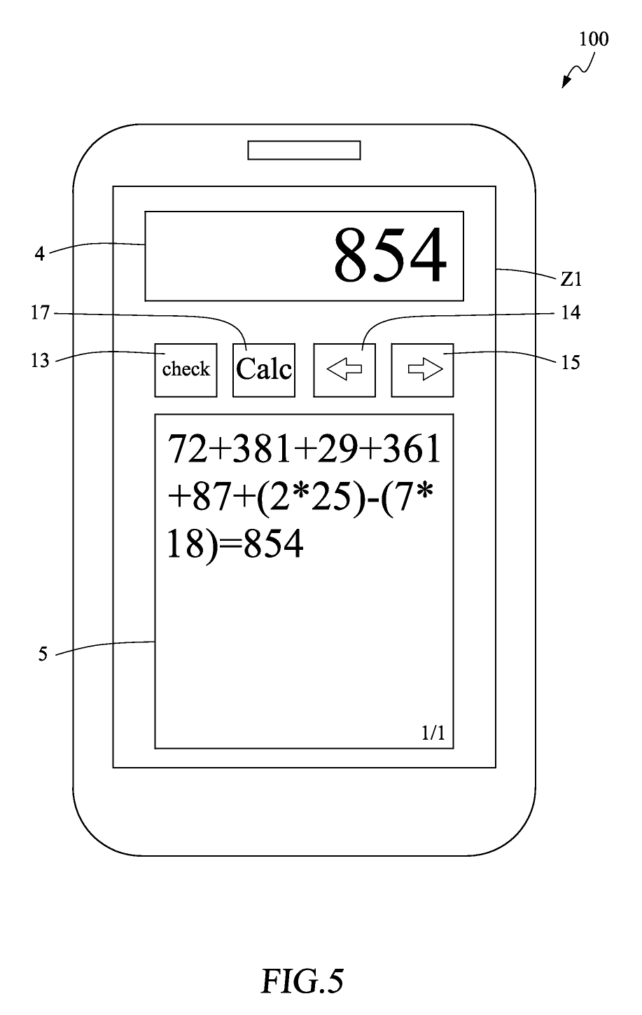

The displaying member 3 then displays the expression and the corresponding calculated result of the expression in the displaying area Z1 by the processing unit P. Specifically, according to this embodiment, the displaying member 3 receives a displaying signal S1 of the expression via the processing unit P so as to display the expression and the corresponding calculated result of the expression in the displaying area Z1, in which a displaying signal S1 of the expression is generated after the user taps an expression displaying button of the inputting member 1. In this embodiment, as shown in FIG. 5, the expression and the corresponding calculated result of the expression are displayed in another displaying frame 5 in the displaying area Z1.

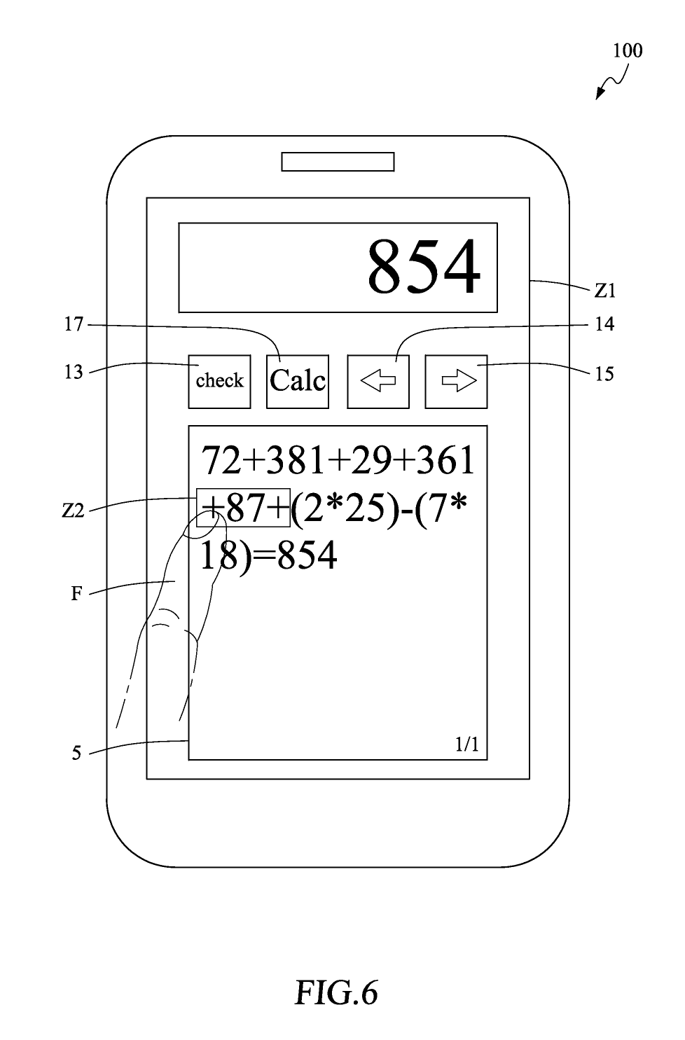

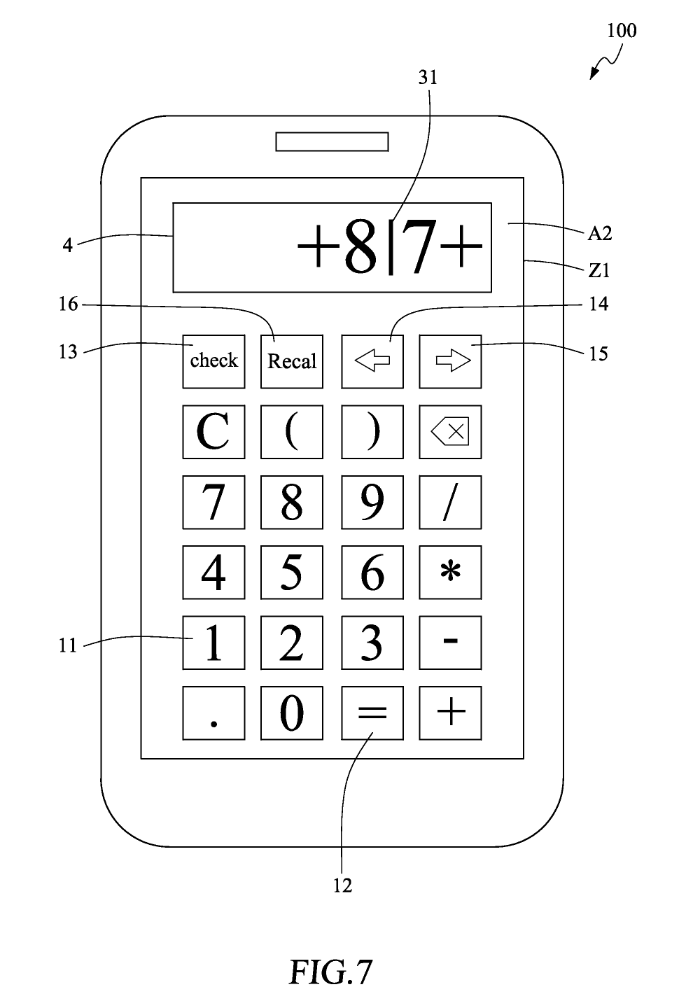

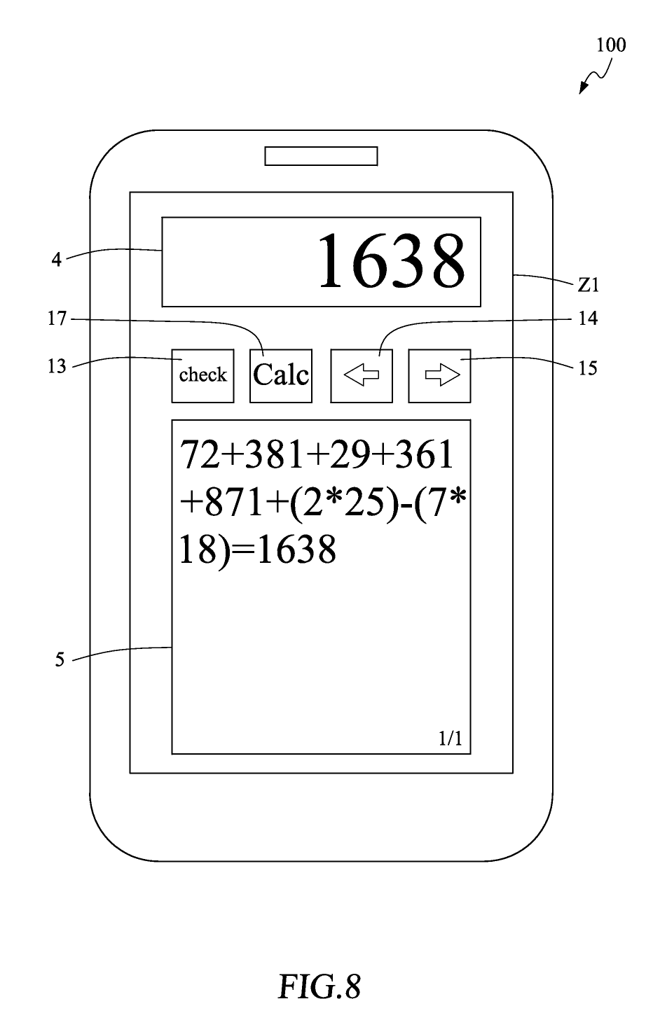

According to an preferred embodiment, the calculator 100 further comprises an expression modifying member 4, which is provided for a user via the processing unit to modify the expression displayed in the displaying area on which the expression and the calculated result of the expression is displayed, wherein the modified expression is re-calculated by the calculating member 2 via the processing unit P to obtain the calculated result of the modified expression. Specifically, as shown in FIG. 6, according to this embodiment, when the user's finger F touches an certain area Z2 of the expression in the displaying frame 5 and release the finger F, the displaying area Z1 will be displayed as switched to an inputting screen A2, as shown in FIG. 7, and the expression in the area Z2 is displayed in the displaying frame 4. The user is then able to modify any portion of the expression in the area Z2, for example, moving a cursor 31 to another position of the expression by tapping a forward button 14 or a backward button 15, and inputting a digit or an arithmetic symbol on the new position of the cursor 31 by tapping the inputting button 11, so as to modify the expression in the area Z2. Then, when the user taps a recalculating button 16 of the inputting member 1, the modified expression and the corresponding calculation result will be displayed in the displaying frame 5 of the displaying area Z1 accordingly, as shown in the FIG. 8. In addition, the calculated result of the expression is displayed correspondingly in the displaying frame 5.

In order to provide convenience for the user to return the displaying member 3 of the calculator 100 to the initial screen A1, according to this embodiment, the inputting member 3 has an initial-screen returning button 17, by which the user taps to have the initial screen A1 displayed in the displaying area Z1, as shown in FIG. 2.

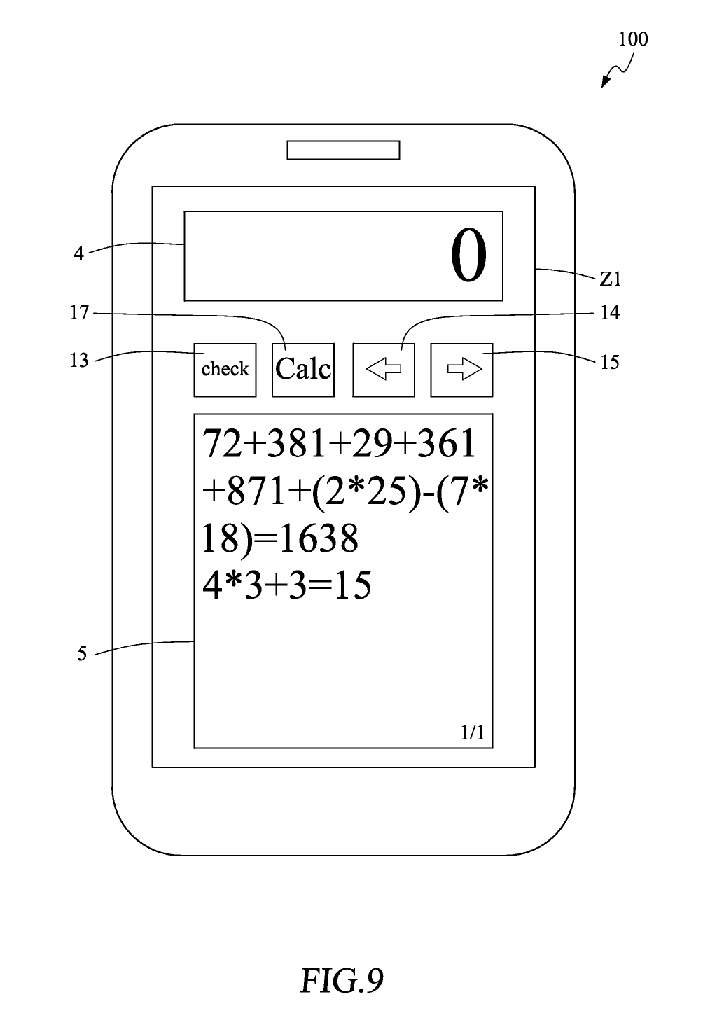

In order to provide convenience for the user to check the calculation history, according to a preferred embodiment, the expressions and the corresponding calculated results of the expression are stored in a memory M, and a plural pairs of corresponding expressions and calculated results of the express may be displayed in the displaying area Z1, as shown in FIG. 9.

The above description should be considered as only the discussion of the preferred embodiments of the present invention. However, a person having with an ordinary skill in the art may make various modifications to the present invention. Those modifications still fall within the spirit and scope defined by the appended claims.

What is claimed is:

1. A calculator, comprising:
an inputting member provided for a user to input an expression;
a calculating member provided for calculating the value of the expression by means of a processing unit and generating a calculated result; and
a displaying member having a displaying area, in which the displaying member displays the expression and the corresponding calculated result of the expression calculated by the processing unit.

2. The calculator of claim 1, wherein the expression and the calculated result of the expression are correspondingly stored in a memory.

3. The calculator of claim 1, wherein the displaying member receives a displaying signal of the expression via the processing unit so as to display the expression and the corresponding calculated result of the expression in the displaying area.

4. The calculator of claim 3, wherein the displaying signal of the expression is generated after a user taps an expression displaying button of the inputting member.

5. The calculator of claim 1, wherein the displaying area is able to display plural pairs of expression and the corresponding calculated result of the expression.

6. The calculator of claim 1, further comprising an expression modifying member which uses the processing unit to modify the expression displayed in the displaying area on which the expression and the calculated result of the expression is displayed, wherein the modified expression is re-calculated by the calculating member via the processing unit to obtain the calculated result of the modified expression.

7. The calculator of claim 6, wherein the inputting member has a recalculating button, and the modified expression and the corresponding calculation result of the modified expression are displayed in the displaying area after a user taps the recalculating button.

8. The calculator of claim 1, wherein the inputting member has an initial-screen returning button by which an initial-screen is displayed in the displaying area after a user taps the initial-screen returning button.
